(19) United States
(12) Patent Application Publication
(10) Pub. No.: US 2024/0292361 A1
(43) Pub. Date: Aug. 29, 2024

(54) TIMING IN NON-TERRESTRIAL CELLULAR COMMUNICATION SYSTEMS

(71) Applicant: Nokia Technologies Oy, Espoo (FI)

(72) Inventors: Jeroen WIGARD, Klarup (DK); Rafhael MEDEIROS DE AMORIM, Aalborg (DK); Frank FREDERIKSEN, Klarup (DK)

(21) Appl. No.: 18/694,161

(22) PCT Filed: Sep. 30, 2021
(86) PCT No.: PCT/EP2021/076915

§ 371 Date: Mar. 21, 2024

(51) Int. Cl. H04W 56/00; H04B 7/185

(52) U.S. Cl. CPC H04W 56/0045; H04B 7/18513

(57) ABSTRACT

A method including, receiving, in an apparatus, a timing advance command from a non-terrestrial network node, checking, in the apparatus, whether the apparatus has received information associated with a timing advance value within a time interval and determining in the apparatus, based on said checking, whether to apply the timing advance command to calculate the timing advance value for communicating with the non-terrestrial network node.

### FIELD

The present disclosure relates to the field of wireless communication, in particular to satellite-enhanced or satellite-based cellular communication systems, and timing of communications therein.

### BACKGROUND

Wireless communication may comprise, in general, cellular and non-cellular wireless communication. Cellular communication systems comprise terrestrial cellular systems, where a radio-access network is arranged to provide service to a coverage area of the terrestrial cellular system. The radio-access network of the terrestrial cellular system is built on land and comprises, in general, a plurality of base station nodes. Such base station nodes may be referred to using different terms depending on the radio-access technology in use.

In case of non-terrestrial cellular systems a networks a space-borne, that is, satellite, or airborne vehicles, may act either as a relay node or as a base station. Non-terrestrial communications may be exploited in various cellular communication networks, such as in cellular communication networks operating according to 5G radio access technology. 5G radio access technology may also be referred to as new radio, NR, access technology. 3rd Generation Partnership Project, 3GPP, develops standards for 5G/NR and some topics in the 3GPP discussions are related to non-terrestrial communications. According to the discussions there is a need to provide improved methods, apparatuses and computer programs related to the use of non-terrestrial communications. Such improvements may be exploited in other cellular communication networks as well.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to receive a timing advance command from a non-terrestrial network node, check whether the apparatus has received information associated with a timing advance value within a time interval and determine, based on said checking, whether to apply the timing advance command to calculate a timing advance value for communicating with the non-terrestrial network node. The apparatus may be a user equipment or a control device configured to be installed in a user equipment.

According to a second aspect of the present disclosure, there is provided a method comprising, receiving, in an apparatus, a timing advance command from a non-terrestrial network node, checking, in the apparatus, whether the apparatus has received information associated with a timing advance value within a time interval and determining in the apparatus, based on said checking, whether to apply the timing advance command to calculate the timing advance value for communicating with the non-terrestrial network node. The method may be performed by a user equipment or a control device configured to be installed in a user equipment.

According to a third aspect of the present disclosure, there is provided an apparatus comprising means for receiving a timing advance command from a non-terrestrial network node, means for checking whether the apparatus has received information associated with a timing advance value within a time interval and means for determining, based on said checking, whether to apply the timing advance command to calculate a timing advance value for communicating with the non-terrestrial network node. The apparatus may be a user equipment or a control device configured to be installed in a user equipment.

According to a fourth aspect of the present disclosure, there is provided a non-transitory computer readable medium having stored thereon a set of computer readable instructions that, when executed by at least one processor, cause an apparatus to at least to perform the method. According to an fifth aspect of the present invention, there is provided a computer program comprising instructions which, when the program is executed by an apparatus, cause the apparatus to carry out the method.

### BRIEF DESCRIPTION OF THE DRAWINGS

FIG. 1 illustrates an example system in accordance with at least some embodiments of the present invention;

FIG. 2 illustrates a problem scenario in accordance with at least some embodiments of the present invention;

FIG. 3 illustrates an example of a process in accordance with at least some embodiments of the present invention;

FIG. 4 illustrates an example apparatus capable of supporting at least some embodiments of the present invention;

FIG. 5 is a flow graph of a method in accordance with at least some embodiments of the present invention.

### EMBODIMENTS

Embodiments of the present invention provide enhancements for non-terrestrial communications in cellular communication networks. More specifically, embodiments of the present invention enable proper timing by avoiding overcompensation of timing errors in Non-Terrestrial Networks, NTNs. A User Equipment, UE, may check whether it has received information associated with a timing advance value within a time interval, before receiving a Timing Advance Command, TAC, from a NTN node. The UE may further ignore the TAC if it has received said information. The network, i.e., the NTN node, may in some cases react on a timing error too slowly and the UE may have already corrected the error itself. Thus, the UE may ignore the TAC to avoid overcompensation in timing.

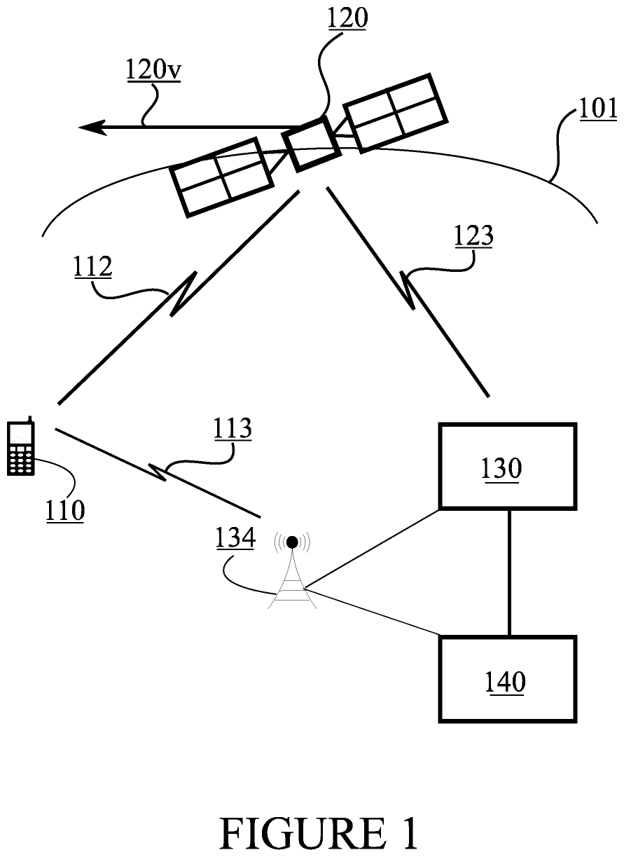

FIG. 1 illustrates an example system in accordance with at least some embodiments of the present invention. Illustrated is UE 110, which may comprise, for example, a machine-type communication device, such as a utility meter, connected car or connected aircraft communication module or an industrial control device. Further, UE 110 may comprise a user device such as a smartphone, feature phone, tablet computer, laptop or desktop computer or a smartwatch, for example. UE 110 may be a NTN UE or a dual-capability UE which is also capable of communicating via terrestrial wireless systems, such as terrestrial cellular and/or non-cellular systems. Examples of terrestrial cellular systems include Long Term Evolution, LTE, and fifth generation, 5G, also known as New Radio, NR. Examples of terrestrial non-cellular systems include Wireless Local Area Network, WLAN, and Worldwide interoperability for Microwave Access, WiMAX.

UE 110 may be furnished with a satellite navigation capability, for example in the form of a satellite navigation receiver installed in UE 110, and be configured to receive signals from a navigation satellite constellation, such as Global Positioning System, GPS, and/or the Galileo constellation. A satellite navigation capability may be used to determine the location and/or current time at UE 110. The satellite navigation satellite constellation may be distinct from a NTN satellite constellation UE 110 is configured to use for communication. Satellite links and NTN communications may be used at least to provide cellular communications to UEs on remote areas, disaster zones or over the sea.

Service link 112 may connect UE 110 with satellite 120. Satellite 120 may be referred to as a non-terrestrial network node, configured to perform non-terrestrial communications with UE 110 over service link 112. Satellite 120 may be in orbit 101 about the Earth, for example in Geostationary Earth Orbit, GEO or Low-Earth Orbit, LEO. A GEO orbit may be defined as an orbit located at approximately 36000 km from Earth, above the equator. The orbit period of GEO satellites may be equivalent to one astronomical day. Therefore, GEO satellites may be static from the point of view of one user, or UE 110, on Earth. The GEO satellites have been around for decades and mostly used for low throughput applications. Recent technical developments have made the GEO deployments significantly attractive for new medium and high throughput applications using satellites.

LEO orbit may be defined as an orbit located at heights between 300 and 1500 km above Earth. LEO satellites may be deployed in different orbit inclinations and orientations around Earth, and travel and significant speeds (approximately 7500 m/s at 600 Kms) and have a very high relative speed from an observer on Earth, such as UE 110.

In case of regenerative architecture, lower layers may be implemented at the hardware located in satellite 120, meaning that some central functions deployed by a BS may deployed at satellite 120, such as scheduling, retransmissions and/or random access. In case of transparent architecture, hardware of satellite 120 may act simply as a repeater or frequency converter, for a BS located on a ground station, such as BS 134, and the latency of the scheduling algorithms may be twice as high as in the case of regenerative architecture. In some example embodiments, satellite 120 may be a transparent relay, meaning that satellite 120 may act as an amplify-and-forward type of relay between UE 110 and an NTN-GW 130 on the Earth's surface.

In some example embodiments, satellite 120 may be a Base Station, BS. For example, in the context of LTE, satellite 120 may be referred to as eNB while satellite 120 may be referred to as gNB in the context of NR. In any case, example embodiments are not restricted to any particular wireless technology. Instead, example embodiments may be exploited in any cellular communication network wherein non-terrestrial communications are used, such as in 6G networks. Satellite 120 may be solar-powered or powered by heat from radioactive decay, for example. The satellite's orbit 101 is, in part, schematically denoted in FIG. 1, as is its momentary orbital velocity vector 120v. Service link 112 may convey information in the downlink, from satellite 120 to UE 110, and in the uplink from UE 110 to satellite 120.

Satellite 120 may be configured to provide its ephemeris information to receivers, such as UEs, on the surface of the Earth. The ephemeris information may comprise information on the satellite's position and movement, at least for a certain time period. For example, the ephemeris information may comprise at least part of the satellite's orbital parameters, such as altitude and the direction and amplitude of velocity vector 120v. Each satellite may serve one or more than one cell. Likewise, each NTN-GW 130 may serve one or more than one cell and/or satellite.

The ephemeris information of satellite 120 may comprise information on at least one inter-satellite connection along a signal path from satellite 120 to NTN-GW 130. In detail, the ephemeris information may comprise the ephemeris information of the satellites along the data path from satellite 120 to NTN-GW 130. Further, the ephemeris information may be condensed to a smaller size when two or more of the satellites along the signal path from satellite 120 to NTN-GW 130 have the same orbit. In that case, the orbital parameters need not be included more than once in the ephemeris information.

Satellite 120 may have feeder link 123 with NTN-GW 130. As is the case with service link 112, feeder link 123 may convey information in both directions, uplink and downlink. Service link 112 and feeder link 123 may wireless links, but they need not comply with the same wireless technology. Although in some embodiments, service link 112 and feeder link 123 may be based on the same wireless technology. NTN-GW 130 may comprise BS 134, or it may be arranged in connection with BS 134, wherefore UE 110 may access a NTN cellular system via satellite 120 such that satellite 120 may act as the bidirectional relay between UE 110 and NTN-GW 130.

One terrestrial BS 134 may control one or more cells, and communicate with UE 110 over air interface 113. In some embodiments, BS 134 may have an interface with NTN-GW 130 or core network 140. NTN-GW 130 maybe connected with further nodes via another gateway or core network 140, for example.

While satellite 120 and UE 110 may be mobile, satellite 120 moreover moving very fast, NTN-GW 130 may be a stationary node. When a constellation of satellites 120 is employed, UE 110 may in principle be almost anywhere, or indeed anywhere, on the Earth's surface. Compared to terrestrial cellular systems, NTN cellular systems may need enhanced timing corrections. Such enhancements are more central in NTN systems due to the long propagation distance, and delay, between UE 110 and satellite 120 over service link 112, but also due to the fast movement of satellite 120 which causes Doppler shifts. Furthermore, in transparent satellites, there is an additional time delay and frequency shift due to feeder link 123 between NTN-GW 130 and satellite 120.

Compared to purely terrestrial cellular communication systems, there are challenges to be addressed in order to provide NTN coverage in a system natively designed to provide terrestrial coverage, such as ultra high speeds and very high latency. The relative speed between a LEO satellite and UE 110 on the ground may be on the range of 7 km/s, which is much higher than anything previously studied, e.g., for 3rd Generation Partnership Project, 3GPP, deployments. Such a high relative speed affects frequency synchronization, channel model, handover rate, etc. Also, the propagation delay of the signal at least in the case of a transparent scenario can be high since the radio signals need to travel from NTN GW 130 through satellite 120 at 400 km height, or even above, and down to UE 110 at earth's surface again. Enhancements are therefore needed to address these issues, to enable NTN communications and applications.

In some example embodiments, when UE 110, initially in idle mode, has detected incoming data on the buffer to be transmitted on uplink, or when UE 110 receives a paging from satellite 120, UE 110 may initiate a switch to the connected mode. For that, UE 110 may send a random access preamble (message 1) towards satellite 120, as a first step of a 4-step random access procedure.

After sending the random access preamble, UE 110 may wait for a random access response (message 2). The random access response may comprise synchronization and identity information of UE 110 to be used towards satellite 120. The random access response may also comprise scheduling information for a subsequent scheduled transmission (message 3).

As a transmission/reception point at satellite 120 may be moving, e.g., with 7.5 km/s, UE 110 may precompensate the timing advance, for instance according to the following equation:

$${T}_{TA} = ( {N}_{TA , UE - specific} + {N}_{TA , UE - common} + {N}_{TA - offset} ) * {T}_{C} \qquad ( 1 )$$

wherein N_{TA} may be defined as 0 for Physical Random Access Channel, PRACH, and updated based on a TAC field in a random access response and Medium Access Control, MAC, Control Element, CE, TAC. N_{TA,UE-specific} may be self-estimated timing advance of UE 110 to pre-compensate for a delay of service link 112. N_{TA,common} may be a network-controlled common timing advance for all UEs in the network, and include any timing offset considered necessary by the network. N_{TA,common} with value of 0 may be supported. N_{TA,offset} may be a fixed offset used to calculate the timing advance value T_{TA}.

N_{TA,UE-specific} may be based on an estimate of UE 110 of its geographical location through Global Navigation Satellite System, GNSS, and knowledge at UE 110 of the position of satellite 120 in space through the ephemeris data, while the network can send timing advance commands (N_{TA,Common} and N_{TA,offset}) as in terrestrial networks.

UE 110 may receive a command from the network, i.e., satellite 120, if it needs to apply the timing advance on top of the precompensation (N_{TA,UE-specific}). This way the network may adjust an offset/constant error or move UE 110 in time to create a margin. For instance, in NR NTN, N_{TA} update based on a TAC field in a random access response and MAC CE TAC may be used for uplink timing alignment correction as follows:
When TAC (T_{A}) in the random access response is received, UE 110 may receive the first adjustment and N_{TA} may be updated as follows:
   N_{TA}=N_{TA_old}+T_{A}*16.64/2^{μ}, where T_{A} is the TAC field in the random access response;
When TAC (T_{A}) provided within the MAC CE is received, N_{TA} may be updated as follows:
   N__{TA_new}=N_{TA_old}+(T_{A}−31)*(16.64)/2^{μ}, where T_{A} is the TAC field received in the MAC CE command.

Errors in GNSS information may be short in time though and hence it may be that the network reacts on a GNSS error by sending a TAC after the error has been already corrected by UE 110 itself. For instance, UE 110 may have determined a new GNSS location before the network reacts to the GNSS error. This may lead to overcompensation and if that happens, the network would need to adjust the timing back, i.e., to correct its own earlier TAC.

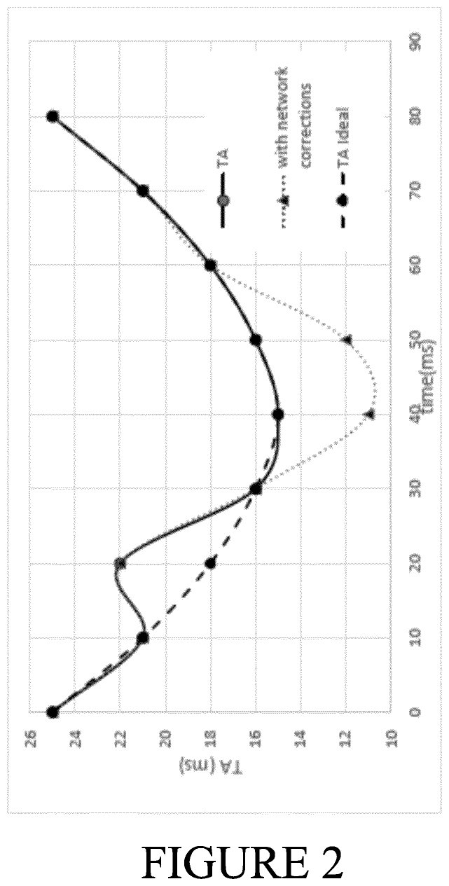

FIG. 2 illustrates a problem scenario in accordance with at least some embodiments of the present invention. In FIG. 2, the Timing Advance, TA, as a function of time is illustrated for UE 110 connected to a NTN, i.e., to satellite 120. The ideal TA is shown along with an example curve where UE 110 is doing all the precompensation (no network commands). Deliberately an error is introduced at time=20 (which can be caused by either an error in the estimation of UE 110 of the geographical location through GNSS or in the prediction of the location of satellite 120 using the provided ephemeris information).

It can be seen that the TA gets back to the ideal curve at time=30 as it got new and updated GNSS information which means the earlier error has disappeared. However, if we address the occurred error with network compensation, one can see that the network tries to correct the error, since the target for the closed loop TA algorithm is to ensure that uplink signals are received with a specific target time. The TA command from the network however arrives after UE 110 has corrected the error so it introduces an additional error which it has then to correct again.

From the problem scenario shown in FIG. 2 it can be seen that the network should not have sent a TA or UE 110 should have ignored the TA even if received. However, there may be occasions where the error is a bias or the network may want to shift the user in time to create a larger margin. In that case the network should be able to use the TA and UE 110 should not ignore it. Embodiments of the present invention therefore provide enhancements for NTN networks to address these issues.

According to some example embodiments, there may be two modes instead of a single mode for the network, comprising satellite 120, for sending TACs. In a conventional mode, the TACs may be taken into account at UE 110 on top of the other parts as described in connection with Equation (1). On the other hand, in a conditional mode UE 110 may apply TACs unless it has received new information within a time interval, i.e., during the last T ms or until it receives new information. If received, said new information may be input to the precompensation algorithm of UE 110. In some example embodiments, the TAC of the conditional mode may be referred to as a TempTAC.

Said new information associated with the timing advance value may comprise information associated with a location of UE 110 and/or common timing advance information. For instance, said new information associated with the location of UE 110 may comprise GNSS information of the location of UE 110 and/or updated ephemeris data. Alternatively, or in addition, said new information may comprise updated TA_{common} information. In some example embodiments, UE 110 may be switched from interpreting the TAC as one of the two at a time or which kind of TA command is given may be embedded in the format of the TA command

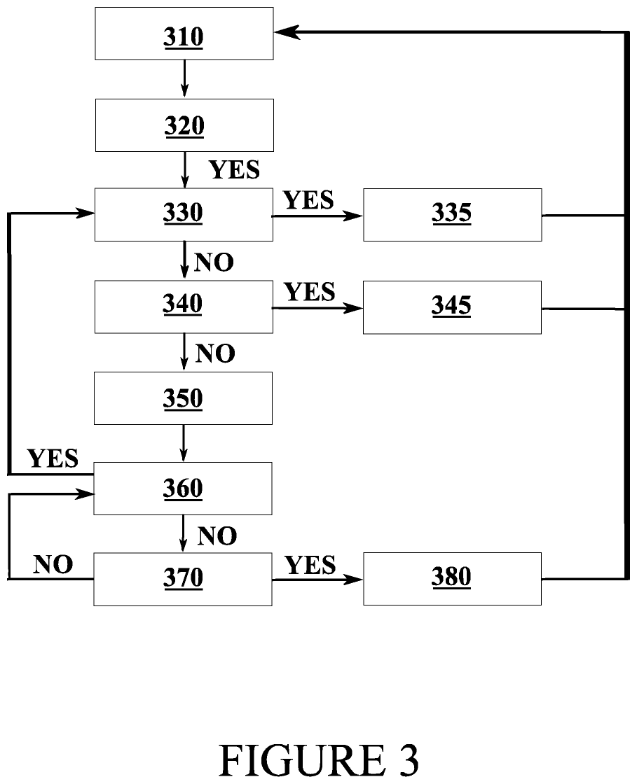

FIG. 3 illustrates an example of a process in accordance with at least some embodiments of the present invention. At step 310, UE 110 may monitor for a transmission of satellite 120 for a TAC. At step 320, UE 110 may receive the TAC from RAN, i.e., from satellite 120. At step 330, UE 110 may check a type of the TAC, e.g., whether the TAC is a conventional TAC or TempTAC. That is, UE 110 may determine whether to check if it has received information associated with a timing advance value within a time interval T before receiving the timing advance command, for example by checking the type of the TAC.

Alternatively, or in addition, said determination may be performed by checking a configuration of UE 110. UE 110 may thus differentiate between two modes, such as a legacy mode and differential TAC mode. In some example embodiments, UE 110 may be configured by the network, such as satellite 120, via Radio Resource Control, RRC, to operate in one mode or the other but it may be a slow operation. Thus, UE 110 may be preferably configured by the network via a Logical Channel Identity, LCID, of a MAC header. The LCID of the MAC header may identify content of the MAC-CE, which may further have different values for the two modes. For example, the LCID 11101 may indicate a TAC. This can be used for the legacy mode. Sequences between 01011-11011 may be reserved and one of them can be used to indicate an “additive” or “differential” TAC. Alternatively, different modes may be indicated by one bit, in the MAC-CE or in a Downlink Control Information, DCI. This can be a toggle bit or a flag bit.

In some example embodiments, upon receiving a TAC type that differs from the previous received ones, e.g., if UE 110 receives a legacy TAC whereas all other previous TACs were “differential”, UE 110 may interpret this as an indication of the confidence of the network in its pre-compensation capabilities. That is, UE 110 may compare a type of the TAC to a type of a previously received TAC and determine, based on the comparison, whether to switch to a different operation mode and/or to transmit the timing advance value and/or UE-specific timing advance to satellite 120.

In some example embodiments, UE 110 may, upon receiving said MAC-CE, switch to a different operation mode. For instance, UE 110 may be configured to perform at least one, or any combination, of the following actions:
upon receiving a legacy TAC, UE 110 may deactivate autonomous compensation for a time window;
upon receiving a legacy TAC, UE 110 may deactivate autonomous compensation until new information is gathered/updated for its GNSS, common delay or other delays in the network;
upon receiving a different TAC UE 110 may change the value for validity timer for the positioning/delay information (increase/decrease); and/or
upon receiving a different TAC the frequency of updates on the side of UE 110 may be modified.

In some example embodiments, there may be more than two modes of MAC-CE commands for T_{A}, such as legacy, differential and legacy with switching off UE synchronization procedures (B1-B4).

In some example embodiments, receiving a different TAC may trigger UE 110 to send a report to the network with its current UE specific TA or total TA (rough or refined value).

In some example embodiments, the value of T may be defined by specifications or may be configured by satellite 120 during connection setup, where the latter may be the preferred embodiment. Via the configuration, satellite 120 may be able to introduce a “grace time” which may cause UE 110 to ignore TACs which are based on old timing information at the side of UE 110.

UE 110 may further determine, based on said checking at step 330, whether to perform further checking or to apply the TAC to calculate the timing advance value without further checking. If it is determined, at step 330, that the TAC is a conventional TAC, the TAC may be applied directly, at step 335, without further checking or processing. For example, the TAC may be applied as in terrestrial networks.

On the other hand, if it is determined at step 330 that the TAC is a TempTAC, UE 110 may check, at step 340, whether it has received new information associated with the timing advance value within a time interval T before receiving the TAC. UE 110 may further determine, based on said checking at step 340, whether to apply the TAC to calculate the timing advance value for communicating with satellite 120.

If it is determined at step 340 that UE 110 has received said information within the time interval, UE 110 may at step 345 ignore the TAC for calculating the timing advance value. For instance, UE 110 may apply a value for 0 for the TAC or compensate for the delta between the new precompensation and the TAC. On the other hand, if it is determined, at step 340, that UE 110 did not receive any new information within said time interval T, UE 110 may at step 350 apply the TAC to calculate the timing advance value. In some example embodiments, UE 110 may remember the TAC, e.g., store the TAC to its memory.

At step 360, UE 110 may determine whether it has received a new TAC and if so, proceed to step 330 again and continue the process from there. On the other hand, if UE 110 has received the new TAC at step 360, UE 110 may check, at step 370 whether it has received new information. If so, UE 110 may, at step 380, apply the timing advance based on the new information, i.e., set the TAC value to 0.

At the end, UE 110 may perform non-terrestrial communication(s), such as transmitting and/or receiving information, with satellite 120, i.e., the NTN node. In general, the timing advance value may be for communicating with satellite 120 and UE 110 may perform non-terrestrial communication(s) with satellite 120 according to the calculated timing advance value.

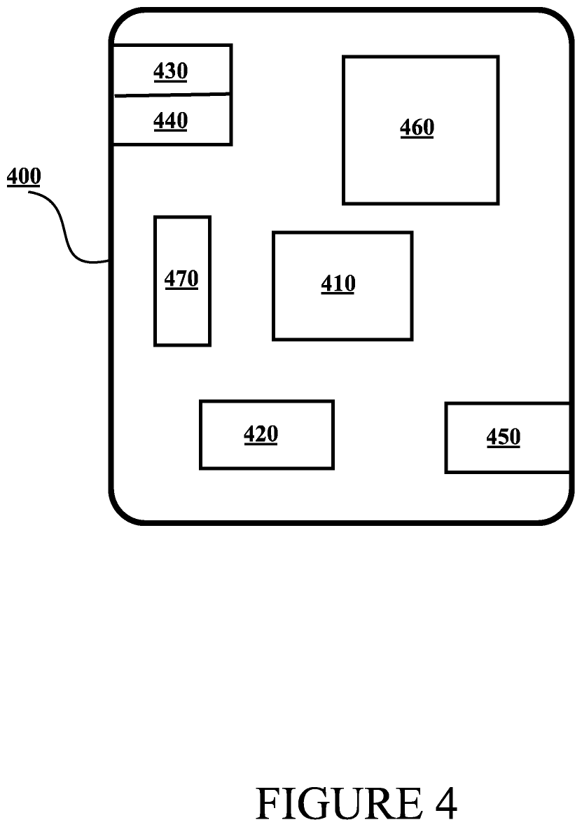

FIG. 4 illustrates an example apparatus capable of supporting at least some embodiments of the present invention. Illustrated is device 400, which may comprise, for example, a device such as UE 110 or, in applicable parts, satellite 120 of FIG. 1 or FIG. 2. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. Processor 410 may be a control device. A processing core may comprise, for example, a Cortex-A8 processing core manufactured by ARM Holdings or a Zen processing core designed by Advanced Micro Devices Corporation. Processor 410 may comprise at least one Qualcomm Snapdragon and/or Intel Xeon processor. Processor 410 may comprise at least one application-specific integrated circuit, ASIC. Processor 410 may comprise at least one field-programmable gate array, FPGA. Processor 410 may be means for performing method steps in device 400, such as receiving, determining, employing, storing, transmitting and/or relaying, for example. Processor 410 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver.

Device 400 may comprise user interface, UI, 450. UI 450 may comprise at least one of a display, a keyboard, a touchscreen, a vibrator arranged to signal to a user by causing device 400 to vibrate, a speaker and a microphone. A user may be able to operate device 400 via UT 450, for example to accept incoming telephone calls, to originate telephone calls or video calls, to browse the Internet, to manage digital files stored in memory 420 or on a cloud accessible via transmitter 430 and receiver 440 and/or to play games.

Device 400 may comprise or be arranged to accept a user identity module 470. User identity module 470 may comprise, for example, a subscriber identity module, SIM, card installable in device 400. A user identity module 470 may comprise information identifying a subscription of a user of device 400. A user identity module 470 may comprise cryptographic information usable to verify the identity of a user of device 400 and/or to facilitate encryption of communicated information and billing of the user of device 400 for communication effected via device 400.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. For example, where device 400 comprises a smartphone, it may comprise at least one digital camera. Some devices 400 may comprise a back-facing camera and a front-facing camera, wherein the back-facing camera may be intended for digital photography and the front-facing camera for video telephony. Device 400 may comprise a fingerprint sensor arranged to authenticate, at least in part, a user of device 400. In some embodiments, device 400 lacks at least one device described above. For example, some devices 400 may lack user identity module 470.

Processor 410, memory 420, transmitter 430, receiver 440, UI 450 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the present invention.

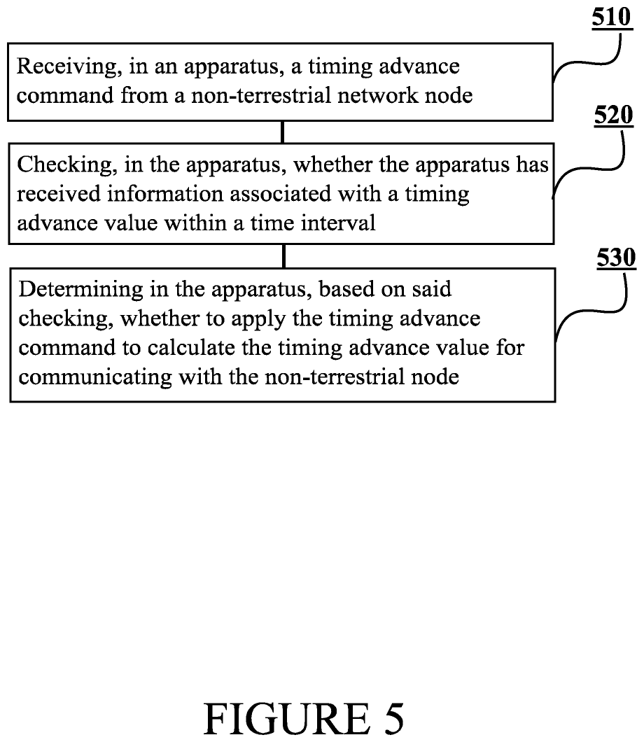

FIG. 5 is a flow graph of a method in accordance with at least some embodiments of the present invention. The phases of the illustrated method may be performed by UE 110, or in a control device configured to control the functioning thereof, when installed therein.

The method may comprise, at step 510, receiving, in an apparatus, a timing advance command from a non-terrestrial network node. The method may also comprise, at step 520, checking, in the apparatus, whether the apparatus has received information associated with a timing advance value within a time interval. Finally, the method may comprise, at step 530, determining in the apparatus, based on said checking, whether to apply the timing advance command to calculate the timing advance value for communicating with the non-terrestrial network node.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in facilitating NTN communication.

### ACRONYMS LIST

3GPP 3rd Generation Partnership Project
CE Control Element
DCI Downlink Control Information
GEO Geostationary Earth Orbit
GNSS Global Navigation Satellite System
GPS Global Positioning System
LCID Logical Channel Identity
LEO Low-Earth Orbit
LTE Long Term Evolution
MAC Medium Access Control
NR New Radio
NTN Non-Terrestrial Network
NTN-GW NTN gateway
PRACH Physical Random Access Channel
RRC Radio Resource Control
TA Timing Advance
TAC Timing Advance Command
UE User Equipment
WiMAX Worldwide interoperability for Microwave Access
WLAN Wireless Local Area Network

REFERENCE SIGNS LIST

| | |
|---|---|
| 101 | Orbit |
| 110 | UE |
| 120 | Satellite (NTN node) |
| 112 | Service link |
| 113 | Interface |
| 123 | Feeder link |
| 120v | Velocity vector |
| 130 | NTN-GW |
| 134 | Terrestrial BS |
| 140 | Gateway or core network |
| 310-380 | Steps of the process of FIG. 3 |
| 400-470 | Structure of the device of FIG. 4 |
| 510-530 | Phases of the method of FIG. 5 |

1.-34. (canceled)

35. An apparatus comprising at least one processing core, at least one memory including computer program code, the at least one memory and the computer program code being configured to, with the at least one processing core, cause the apparatus at least to:
receive a timing advance command from a non-terrestrial network node;
check whether the apparatus has received information associated with a timing advance value within a time interval; and
determine, based on said checking, whether to apply the timing advance command to calculate a timing advance value for communicating with the non-terrestrial network node.

36. The apparatus according to claim 35, wherein said information associated with the timing advance value comprises information associated with a location of the apparatus, updated ephemeris data and/or common timing advance information.

37. The apparatus according to claim 36, wherein said information associated with the location of the apparatus comprises global navigation satellite system information of the location of the apparatus.

38. The apparatus according to claim 35, wherein the at least one memory and the computer program code are further configured to, with the at least one processing core, cause the apparatus at least to:
ignore the timing advance command when it is determined that the apparatus has received said information within said time interval before receiving the timing advance command or after receiving the timing advance command.

39. The apparatus according to claim 35, wherein the at least one memory and the computer program code are further configured to, with the at least one processing core, cause the apparatus at least to:
apply the timing advance command when it is determined that the apparatus has not received said information within said time interval.

40. The apparatus according to claim 35, wherein the at least one memory and the computer program code are further configured to, with the at least one processing core, cause the apparatus at least to:
determine whether to perform said checking or to apply the timing advance command to calculate the timing advance value without said checking.

41. The apparatus according to claim 35, wherein the at least one memory and the computer program code are further configured to, with the at least one processing core, cause the apparatus at least to:
determine whether to perform said checking or to apply the timing advance command to calculate the timing advance value without said checking by checking a type of the timing advance command and/or a configuration of the apparatus.

42. The apparatus according to claim 41, wherein the type of the timing advance command is a legacy type or a conditional type.

43. The apparatus according to claim 41, wherein the configuration of the apparatus is received via radio resource control signalling or in a logical channel identity of a medium access control header.

44. The apparatus according to claim 35, wherein the at least one memory and the computer program code are further configured to, with the at least one processing core, cause the apparatus at least to:
compare a type of the timing advance command to a type of a previously received timing advance command; and
determine, based on the comparison, whether to switch to a different operation mode and/or to transmit the timing advance value and/or an apparatus specific timing advance to the non-terrestrial network node.

45. An apparatus, comprising:
means for receiving a timing advance command from a non-terrestrial network node;
means for checking whether the apparatus has received information associated with a timing advance value within a time interval; and
means for determining, based on said checking, whether to apply the timing advance command to calculate a timing advance value for communicating with the non-terrestrial network node.

46. The apparatus according to claim 45, wherein said information associated with the timing advance value comprises information associated with a location of the apparatus, updated ephemeris data and/or common timing advance information.

47. The apparatus according to claim 46, wherein said information associated with the location of the apparatus comprises global navigation satellite system information of the location of the apparatus and/or updated ephemeris data.

48. The apparatus according to claim 45, further comprising:
means for ignoring the timing advance command when it is determined that the apparatus has received said information within said time interval before receiving the timing advance command or after receiving the timing advance command.

49. The apparatus according to claim 45, further comprising:
means for applying the timing advance command when it is determined that the apparatus has not received said information within said time interval.

50. The apparatus according to claim 45, further comprising:
means for determining whether to perform said checking or to apply the timing advance command to calculate the timing advance value without said checking.

51. The apparatus according to claim 45, further comprising:
means for determining whether to perform said checking or to apply the timing advance command to calculate the timing advance value without said checking by checking a type of the timing advance command and/or a configuration of the apparatus.

52. The apparatus according to claim 51, wherein the type of the timing advance value is a legacy type or a conditional type.

53. The apparatus according to claim 51, wherein the configuration of the apparatus is received via radio resource control signalling or in a logical channel identity of medium access control header.

54. The apparatus according to claim 45, further comprising:
means for comparing a type of the timing advance command to a type of a previously received timing advance command; and
means for determining, based on the comparison, whether to switch to a different operation mode and/or to transmit the timing advance value and/or an apparatus specific timing advance to the non-terrestrial network node.
